(19) United States
(12) Patent Application Publication
(10) Pub. No.: US 2024/0079716 A1
(43) Pub. Date: Mar. 7, 2024

(54) TRACTION BATTERY PACK VENTING ASSEMBLY AND METHOD OF ESTABLISHING A TRACTION BATTERY PACK VENT PATH

(71) Applicant: Ford Global Technologies, LLC, Dearborn, MI (US)

(72) Inventors: Michael E. Reibling, Sterling Heights, MI (US); Patrick Daniel Maguire, Ann Arbor, MI (US); Brock Dunlap, Dearborn, MI (US); Deanna Marie Winton Hoffman, Ann Arbor, MI (US); Mohammadreza Eftekhari, Novi, MI (US); David Wilson, South Lyon, MI (US); Kevin Durand Byrd, Novi, MI (US)

(21) Appl. No.: 18/155,006

(22) Filed: Jan. 16, 2023

Related U.S. Application Data
(60) Provisional application No. 63/403,445, filed on Sep. 2, 2022.

(51) Int. Cl. H01M 50/325; B60L 50/64; H01M 50/209; H01M 50/367

(52) U.S. Cl. CPC H01M 50/325; B60L 50/64; H01M 50/209; H01M 50/367; H01M 2220/20

(57) ABSTRACT

A traction battery pack venting assembly includes an enclosure, at least one cell stack within the enclosure, a cross-member assembly within the enclosure, and a valve assembly that opens to provide a vent path from the at least one cell stack to a passageway of the cross-member assembly. A method of establishing a vent path within a traction battery pack includes, within a battery pack enclosure, using a valve assembly to block an opening to a passageway provided by a cross-member assembly; and in response to at least one battery cell within the battery pack enclosure venting, opening the valve assembly to permit flow through the opening to the passageway.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to venting gas and debris from a traction battery pack and, more particularly, to utilizing a valve assembly to establish a desired vent path.

### BACKGROUND

A traction battery pack of an electrified vehicle can include groups of battery cells arranged in one or more cell stacks. From time to time, pressure and thermal energy within one or more of the battery cells can increase. Gas and debris can then be released from those battery cells.

### SUMMARY

In some aspects, the techniques described herein relate to a traction battery pack venting assembly, including: an enclosure; at least one cell stack within the enclosure; a cross-member assembly within the enclosure; and a valve assembly that opens to provide a vent path from the at least one cell stack to a passageway of the cross-member assembly.

In some aspects, the techniques described herein relate to an assembly, wherein the cell stack includes a plurality of battery cells and at least one divider distributed along a cell stack axis, the at least one divider compartmentalizing an interior of the enclosure into a plurality of compartments, each of the compartments holding at least one of the battery cells.

In some aspects, the techniques described herein relate to an assembly, wherein the valve assembly is a first valve, and further including a second valve, the first valve assembly configured to open to provide a vent path from a first one of the plurality of compartments to the passageway, the second valve assembly configured to open to provide a vent path from a second one of the plurality of compartments to the passageway.

In some aspects, the techniques described herein relate to an assembly, wherein the valve assembly is configured to open in response to at least one battery cell of the battery cells venting.

In some aspects, the techniques described herein relate to an assembly, wherein the valve assembly is a first valve assembly provided by a first perforated area within a sheet of material, and further including a second valve assembly provide by a second perforated area within the sheet of material, the first valve assembly configured to open to provide a vent path from a first one of the plurality of compartments to the passageway, the second valve assembly opening to provide a vent path from a second one of the plurality of compartments to the passageway.

In some aspects, the techniques described herein relate to an assembly, wherein the sheet of material is a sheet of silicone.

In some aspects, the techniques described herein relate to an assembly, wherein the valve assembly includes a flap that opens inward into the passageway.

In some aspects, the techniques described herein relate to an assembly, wherein the valve assembly is a reed valve.

In some aspects, the techniques described herein relate to an assembly, wherein the valve assembly is configured to transition from a flow-restricting position to a flow-permitting position, the valve assembly in the flow-permitting position permitting more flow through an opening in the cross-member assembly that the valve assembly in the flow-restricting position.

In some aspects, the techniques described herein relate to an assembly, wherein the valve assembly is provided by a perforated area within a sheet of material.

In some aspects, the techniques described herein relate to an assembly, wherein the valve assembly opens to permit flow through an opening of the cross-member assembly to the passageway, and further including a baffle of the cross-member assembly that redirects flow through the opening to move toward an axial end of the cross-member assembly.

In some aspects, the techniques described herein relate to an assembly, wherein the valve assembly includes a plurality of flaps that open without inverting to permit flow through the valve assembly in a first direction, wherein inverting the plurality of flaps is necessary to permit flow through the valve assembly is an opposite, second direction.

In some aspects, the techniques described herein relate to an assembly, wherein the valve assembly is a piece of tape adhesively secured to the cross-member assembly.

In some aspects, the techniques described herein relate to an assembly, wherein the valve assembly is a tapered plug that fits within an opening of the cross-member assembly.

In some aspects, the techniques described herein relate to an assembly, wherein the at least one cell stack includes a first cell stack and a second cell stack, the cross-member assembly disposed between the first and second cell stacks, wherein the valve assembly is a first valve assembly within a plurality of first valve assemblies that block flow through an plurality of first openings on a first side of the cross-member assembly, the first valve assemblies each openable to provide a respective vent path from the at least one first cell stack to the passageway, and, further including a plurality of second valve assemblies that block flow through a plurality of second openings on an opposite, second side of the cross-member assembly, the second valve assemblies each openable to provide a respective vent path from the second cell stack to the passageway.

In some aspects, the techniques described herein relate to an assembly, wherein the valve assembly is a one-way valve.

In some aspects, the techniques described herein relate to a method of establishing a vent path within a traction battery pack, including: within a battery pack enclosure, using a valve assembly to block an opening to a passageway provided by a cross-member assembly; and in response to at least one battery cell within the battery pack enclosure venting, opening the valve assembly to permit flow through the opening to the passageway.

In some aspects, the techniques described herein relate to a method, wherein the valve assembly is secured to an interior surface of the cross-member assembly.

In some aspects, the techniques described herein relate to a method, wherein the opening is a first opening on a first side of the cross-member assembly, and, further including, in response to at least one other battery cell within the battery pack enclosure venting, opening a valve assembly to permit flow through a second opening to the passageway, the second opening on an opposite, second side of the cross-member assembly.

In some aspects, the techniques described herein relate to a method, wherein the valve assembly is a one-way valve.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 2.

FIG. 3 illustrates a perspective view of selected portions of a cell stack and cross-member assembly from the traction battery pack of FIG. 2 with valve assemblies removed to show openings within the cross-member assembly.

FIG. 4 illustrates a schematic section view of valve assemblies, a cross-member assembly, and two cell stacks from the traction battery pack of FIG. 2.

FIG. 5 illustrates a selected portion of a cross-member assembly along with a valve assembly according to another exemplary aspect of the present disclosure.

FIG. 6 illustrates a selected portion of a cross-member assembly along with a valve assembly according to yet another exemplary aspect of the present disclosure.

FIG. 7 illustrates a selected portion of a cross-member assembly along with a valve assembly according to yet another exemplary aspect of the present disclosure.

FIG. 8 illustrates a side view of one of the valve assemblies from the valve assembly of FIG. 7.

FIG. 9 illustrates a perspective view of a portion of a cross-member assembly and a valve assembly according to yet another exemplary aspect of the present disclosure.

FIG. 10 illustrates a section view of a cross-member assembly and a valve assembly and according to yet another exemplary aspect of the present disclosure.

### DETAILED DESCRIPTION

This disclosure details exemplary venting assemblies for a traction battery pack. The venting assemblies can include valve assemblies that open to permit venting one or more battery cells into a passageway of a cross-member assembly.

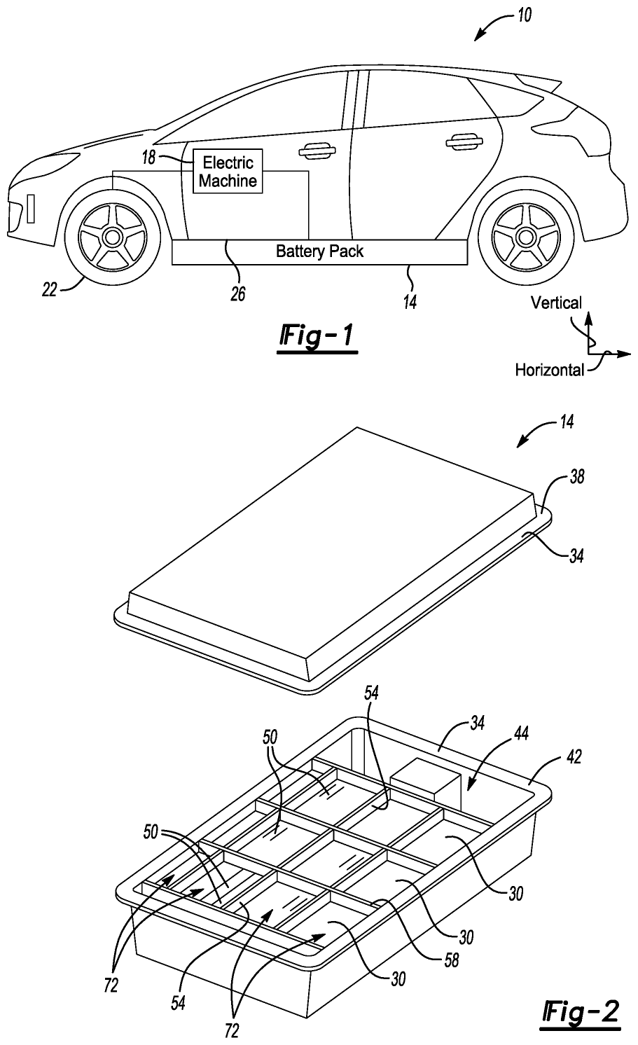

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

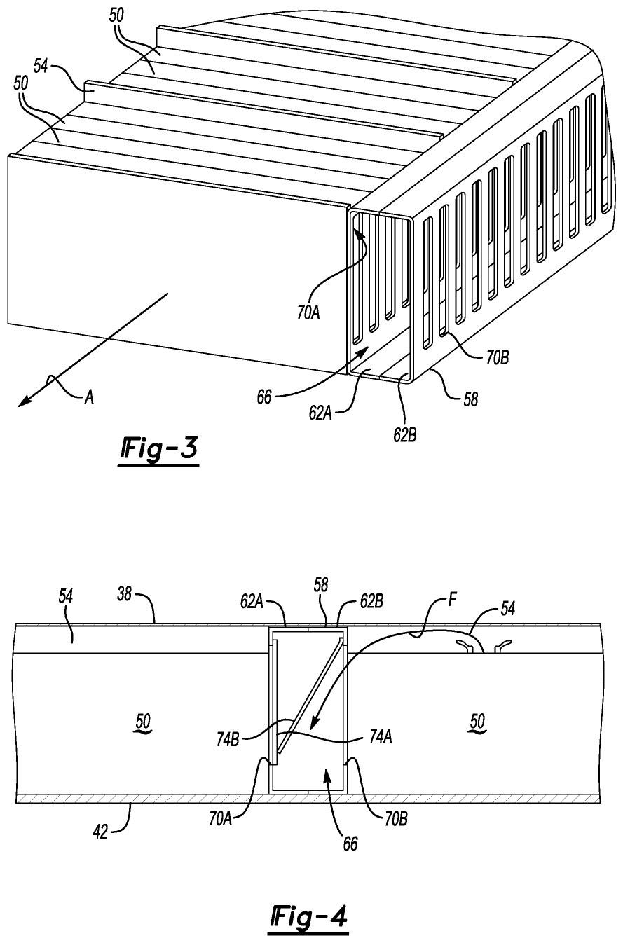

With reference now to FIGS. 2-4, the battery pack 14 includes a plurality of cell stacks 30 held within an enclosure 34. In the exemplary embodiment, the enclosure 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply “cells”) and at least one divider 54 distributed along a respective cell stack axis A. The battery cells 50 are stacked side-by-side relative to each along the cell stack axis A. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure. The exemplary battery cells 50 can include tab terminals extending from a battery cell housing. An aluminum film provides the housing, for example.

From time to time, pressure and thermal energy within one or more of the battery cells 50 can increase. The pressure and thermal energy increase can be due to, for example, an overcharge condition. The pressure and thermal energy increase can cause the associated battery cell 50 to rupture and vent gas and debris from within the interior of that battery cell 50.

In some examples, the gas and debris are released from the battery cell 50 through a designated vent within the housing, such as a membrane that yields in response to an increased pressure. The venting can instead or additionally be venting though a ruptured area of the associated battery cell 50.

The exemplary battery pack 14 incorporates features and design elements that facilitate communicating vented gas and debris from the battery cells 50 to an area outside the battery pack enclosure 34. The features and design elements inhibit the vented gas and debris from moving near battery cells 50 that are not venting, which can help to prevent a thermal event cascading to those other battery cells 50

In particular, within the battery pack enclosure 34, cross-member assemblies 58 are disposed between the cell stacks 50. In the exemplary embodiment, the cross-member assemblies 58 each include a first beam 62A and a second beam 62B. The beams 62A and 62B of the example cross-member assemblies 58 each have a general C-shaped cross-section. The beams 62A and 62B can be positioned side by side to establish a passageway 66 within the cross-member assemblies 58.

The beam 62A includes a plurality of openings 70A facing the cell stack 30 on a first side of the cross-member assembly 58. The beam 62B includes a plurality of openings 70B facing the cell stack 30 on an opposite, second side of the cross-member assembly 58.

Within each of the cell stacks 30, the dividers 54 compartmentalize at least one battery cell 50. The compartmentalizing substantially encloses at least one battery cell 50 within a compartment 72 defined by the enclosure 34, cross-member assemblies 58, and the dividers 54. The compartmentalizing effectively encloses groups of the battery cells 50 within various compartments 72.

The compartments 72 can each hold one or more of the battery cells 50 within one of the cell stacks 30. In the exemplary embodiment, the battery cells 50 of each cell stack 30 are held within one of four compartments 72. Other numbers of the compartments 72 could be used in other examples.

Compartmentalizing battery cells 50 helps to block gas and debris vented from one or more of the cells 50 from moving along the axis A of a given cell stack 30 and heating other battery cells 50 of that cell stack 30. Due to the dividers 54 and the enclosure 34, gas and debris vented from one or more of the battery cells within one of the compartments 72 is directed toward openings 70A or 70B within the cross-member assembly 58 and into the passageway 66.

During ordinary operation, when none of the battery cells 50 within the various cell stacks 30 are venting, the openings 70A and 70B are covered by a valve assembly 74A or 74B. FIG. 4 shows an exemplary valve assembly 74A associated with at least one of the openings 70A in the first beam 62A, and another valve assembly 74B associated with at least one of the openings 70B in the second beam 62B.

The valve assembly 74A is shown in a flow-restricting position where the valve assembly 74A blocks a flow F of gas and debris within the passageway 66 from moving through the opening 70A and near to some of the battery cells 50. This can help to prevent battery cells 50 that are not venting from experiencing a thermal event.

The valve assembly 74B is shown in an flow-permitting position where the valve assembly 74B has moved away from the respective opening 70B to permit the flow F of vented gas and debris from one of the battery cells 50 through the opening 70B into the passageway 66. The valve assembly 74B moves to the flow-permitting position by swinging away from the opening 70B. The valve assembly 74B can swing away from the opening 70B due to the increased pressure associated with the flow F. Moving the valve assembly 74B to the flow-permitting position provides a vent path from the battery cells 50 though the opening 70B to the passageway 66. The valve assembly 74A or 74B could also be hinged to promote vent gas along the passageway to the passenger side or the driver side if, for instance, all exhaust paths to the exterior environment were only on the passenger side or the driver side of the battery pack 14.

The flow F of vented gas and debris can move within the passageway 66 along a length of the cross-member assembly 58 and, for example, through a one-way exit valve assembly in the enclosure 34 to an area outside the battery pack 14.

The example valve assemblies 74A and 74B are flaps that open inward into the passageway 66. The valve assemblies 74A and 74B can be adhesively secured, for example, to an interior surface of the cross-member assembly 58. In this example, the valve assemblies 74A and 74B are adhesively secured to the cross-member assembly 58 vertically above the respective opening 70A or 70B. Vertical, for purposes of this disclosure, is with reference to ground in an ordinary orientation of the battery pack when installed within the vehicle of FIG. 1.

The valve assemblies 74A and 74B are substantially any valve assembly configured to open in response to at least one battery cell 50 venting to permit the flow F of gas and debris from that battery cell 50 into the passageway 66. In some examples, the valve assemblies 74A and 74B are considered reed valve assemblies.

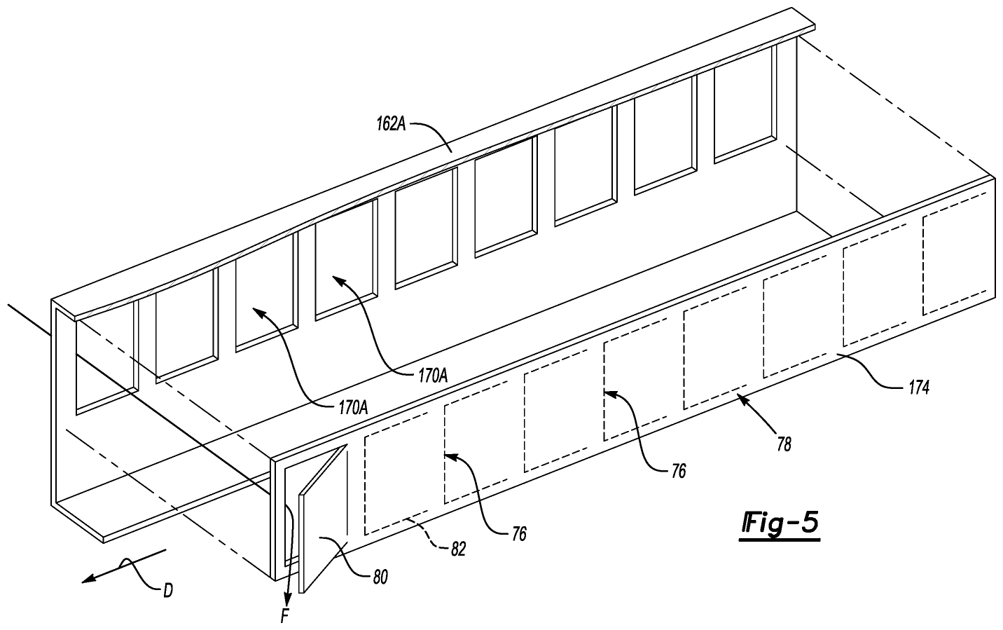

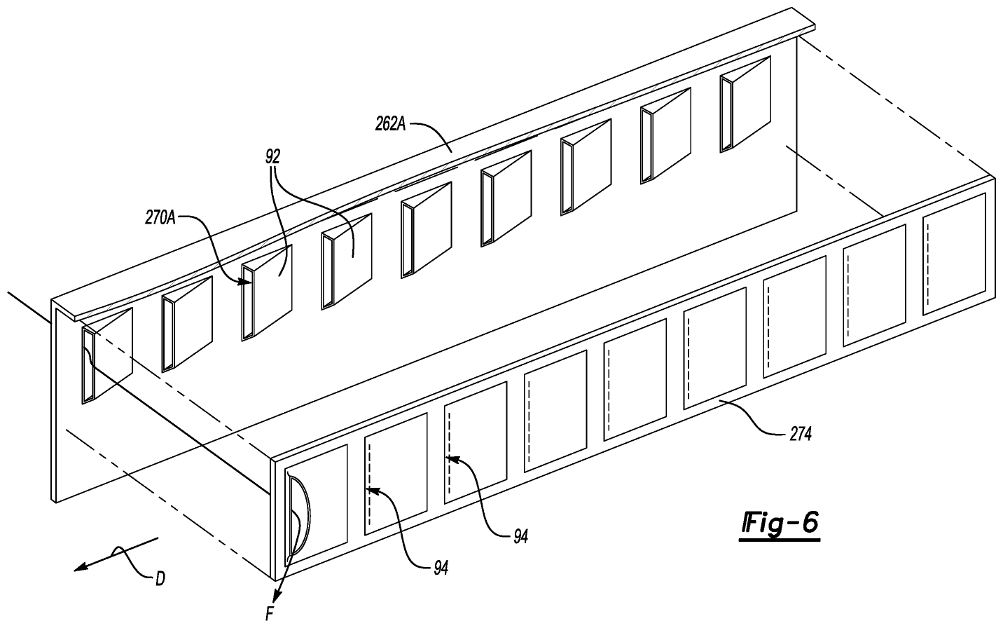

With reference now to FIG. 5, a valve assembly 174 according to another exemplary embodiment is secured to a beam 162A to cover openings 170A within the beam 162A. The valve assembly 174 includes a plurality of perforated areas 76 and an attachment region 78 about the perimeter of the valve assembly 174. The attachment region 78 is adhesively secured to the beam 162A to cover the openings 170A. The valve assembly 174 can be provided by a sheet of material, such as a sheet of silicone.

When battery cells 50 vent, the flow F moves against the valve assembly 174 and tears the associated perforated areas 76 so that the flow F can move through the one or more of the openings 170A and the torn area into a passageway 166 at least partially provided by the beam 162A.

Notably, the perforated areas 76 have a C-shaped profile. When the perforated areas 76 are torn, a resulting flap 80 remains secured to the other portions of the valve assembly 174. Keeping the flap 80 secured can help to guide the flow in a desired direction through the passageway 66. For example, when one or more of the perforated areas 86 in FIG. 5 is torn, a flow of gas and debris would tend to move through the opening 170 and then in a direction D through the passageway rather than a direction opposite the direction D.

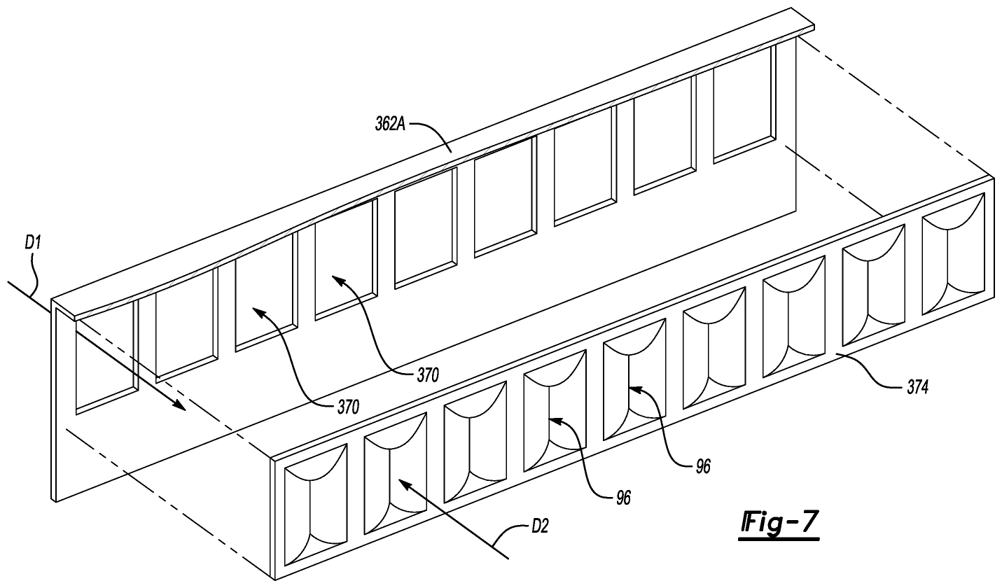

With reference now to FIG. 6, another example valve assembly 274 can be utilized in connection with a beam 262A of a cross-member assembly. The beam 262A helps to establish a passageway of a cross-member assembly. The beam 262A incorporates baffles 92 that further help to redirect and guide the flow F of gas and debris in the direction D through a passageway 266. Redirecting the flow F helps to move the flow F to an axial end of the beam 262A rather than other battery cells 50. The baffles 92 are associated with each opening 270A within the beam 262A.

The valve assembly 274 can be adhesively secured to the beam 262A such that perforated areas of the valve assembly 274 are generally aligned with the openings 270A.

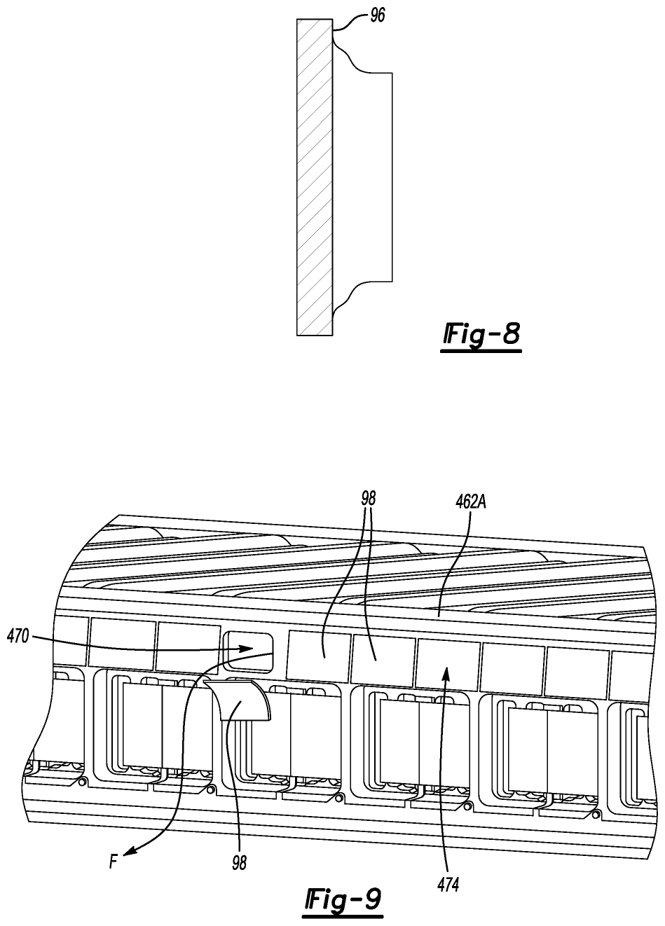

With reference now to FIGS. 7 and 8, another exemplary valve assembly 374 includes a plurality of molded-in lips or flaps 96, which are normally closed. Opening the flaps 96 is required to permit flow through the openings 370 in a beam 362A.

The flaps 96 can open to permit flow through the openings 370. The pressure required to open the flaps 96 to permit flow in a direction D1 (from one of the compartments holding the battery cells) can be much lower than the pressure required to open the flaps 96 and permit flow F in a direction D2. This is due to, among other things, the flaps 96 needing to invert in order for flow F to move through the valve assemblies 374 in the direction D2.

The size of the valve assemblies 374 and the geometries of the valve assemblies 374 may be adjusted to tune a pressure differential required to open the valve assemblies 374.

When the valve assemblies 374 are utilized in connection with the openings 370, the flow F of gas and debris vented from one or more battery cells 50 moves in a direction D1 through the associated openings 370 and then through the valve assemblies 374. Requiring a higher pressure to open the valve assemblies 374 and permit flow in an opposite direction D2 helps to ensure that gas and debris moved through one of the valve assemblies 374 does not flow back through another one of the valve assemblies valve assemblies 374 to other battery cells 50. Instead, the flow F of gas and debris moves along the passageway to exit the associated traction battery pack.

FIG. 9 shows yet another valve assembly 474, which comprises a plurality of individual pieces of tape or thermally resistant material 98, such as mica or high temperature resistance plastic, secured over respective openings 470 within a beam 462A of a cross-member assembly. As can be appreciated, the flow F of gas and debris moved through one of the openings 470 can press against the associate piece of tape 98 to break the adhesive bond between the tape 98 and the beam 462A. With this bond broken, the tape 98 falls away from the beam 462A, which allows the flow F of gas and debris to move through the opening 470 into a passageway at least partially provided by the beam 462A. In this example, each of the openings 470 is covered by a single piece of the tape 98. In another example, a single piece of tape 98 could cover more than one of the openings 470.

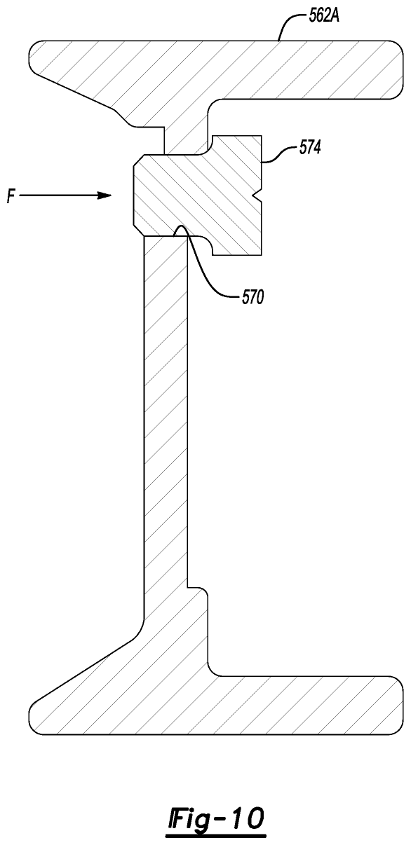

FIG. 10 shows a cross-section of yet another example valve assembly 574, which is essentially a tapered plug fit within one of the openings 570 within a beam 562A. A flow F of gas and debris can press against the valve assembly 574 to dislodge the valve assembly 574 so that the flow F can move through the opening 570 into a passageway at least partially provided by the beam 562A.

For any of the above exemplary embodiments, an example method of establishing a vent path within a traction battery pack can include using a valve assembly to block an opening to a passageway provided by a cross-member assembly. The method includes opening the valve assembly to permit flow through the opening to the passageway. The valve assembly opens in response to at least one battery cell within the battery pack enclosure venting.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack venting assembly, comprising:
an enclosure;
at least one cell stack within the enclosure;
a cross-member assembly within the enclosure; and
a valve assembly that opens to provide a vent path from the at least one cell stack to a passageway of the cross-member assembly.

2. The assembly of claim 1, wherein the cell stack includes a plurality of battery cells and at least one divider distributed along a cell stack axis, the at least one divider compartmentalizing an interior of the enclosure into a plurality of compartments, each of the compartments holding at least one of the battery cells.

3. The assembly of claim 2, wherein the valve assembly is a first valve, and further comprising a second valve, the first valve assembly configured to open to provide a vent path from a first one of the plurality of compartments to the passageway, the second valve assembly configured to open to provide a vent path from a second one of the plurality of compartments to the passageway.

4. The assembly of claim 2, wherein the valve assembly is configured to open in response to at least one battery cell of the battery cells venting.

5. The assembly of claim 2, wherein the valve assembly is a first valve assembly provided by a first perforated area within a sheet of material, and further comprising a second valve assembly provide by a second perforated area within the sheet of material, the first valve assembly configured to open to provide a vent path from a first one of the plurality of compartments to the passageway, the second valve assembly opening to provide a vent path from a second one of the plurality of compartments to the passageway.

6. The assembly of claim 5, wherein the sheet of material is a sheet of silicone.

7. The assembly of claim 1, wherein the valve assembly comprises a flap that opens inward into the passageway.

8. The assembly of claim 1, wherein the valve assembly is a reed valve.

9. The assembly of claim 1, wherein the valve assembly is configured to transition from a flow-restricting position to a flow-permitting position, the valve assembly in the flow-permitting position permitting more flow through an opening in the cross-member assembly that the valve assembly in the flow-restricting position.

10. The assembly of claim 1, wherein the valve assembly is provided by a perforated area within a sheet of material.

11. The assembly of claim 1, wherein the valve assembly opens to permit flow through an opening of the cross-member assembly to the passageway, and further comprising a baffle of the cross-member assembly that redirects flow through the opening to move toward an axial end of the cross-member assembly.

12. The assembly of claim 1, wherein the valve assembly comprises a plurality of flaps that open without inverting to permit flow through the valve assembly in a first direction, wherein inverting the plurality of flaps is necessary to permit flow through the valve assembly is an opposite, second direction.

13. The assembly of claim 1, wherein the valve assembly is a piece of tape adhesively secured to the cross-member assembly.

14. The assembly of claim 1, wherein the valve assembly is a tapered plug that fits within an opening of the cross-member assembly.

15. The assembly of claim 1, wherein the at least one cell stack includes a first cell stack and a second cell stack, the cross-member assembly disposed between the first and second cell stacks, wherein the valve assembly is a first valve assembly within a plurality of first valve assemblies that block flow through an plurality of first openings on a first side of the cross-member assembly, the first valve assemblies each openable to provide a respective vent path from the at least one first cell stack to the passageway, and, further comprising a plurality of second valve assemblies that block flow through a plurality of second openings on an opposite, second side of the cross-member assembly, the second valve assemblies each openable to provide a respective vent path from the second cell stack to the passageway.

16. The assembly of claim 1, wherein the valve assembly is a one-way valve.

17. A method of establishing a vent path within a traction battery pack, comprising:
within a battery pack enclosure, using a valve assembly to block an opening to a passageway provided by a cross-member assembly; and
in response to at least one battery cell within the battery pack enclosure venting, opening the valve assembly to permit flow through the opening to the passageway.

18. The method of claim 17, wherein the valve assembly is secured to an interior surface of the cross-member assembly.

19. The method of claim 17, wherein the opening is a first opening on a first side of the cross-member assembly, and, further comprising, in response to at least one other battery cell within the battery pack enclosure venting, opening a valve assembly to permit flow through a second opening to the passageway, the second opening on an opposite, second side of the cross-member assembly.

20. The method of claim 17, wherein the valve assembly is a one-way valve.
